(19) United States
(12) Patent Application Publication
(10) Pub. No.: US 2023/0416573 A1
(43) Pub. Date: Dec. 28, 2023

(54) ADHESIVE TAPE FOR JACKETING ELONGATE ITEMS SUCH AS ESPECIALLY CABLE HARNESSES AND METHODS FOR JACKETING

(71) Applicant: TESA SE, NORDERSTEDT (DE)

(72) Inventors: Fabian BROCKMEYER, Hamburg (DE); Mark HANLE, Hamburg (DE); Daniel SCHMITZ-STAPELA, Hamburg (DE); Mathias HANISCH, Hamburg (DE); Georg SCHMIEDEL, Hamburg (DE); Jacob PRZYOJSKI, Howard City, MI (US)

(73) Assignee: TESA SE, NORDERSTEDT (DE)

(21) Appl. No.: 18/235,537

(22) Filed: Aug. 18, 2023

Related U.S. Application Data
(63) Continuation of application No. 17/036,633, filed on Sep. 29, 2020.

(51) Int. Cl. C09J 7/38; C09J 7/25; C09J 7/21

(52) U.S. Cl. CPC C09J 7/385; C09J 7/255; C09J 7/21; C09J 2203/302; C09J 2467/006; C09J 2301/414; C09J 2301/302; C09J 2433/00

(57) ABSTRACT

Adhesive tapes comprise a textile carrier and a pressure-sensitive adhesive, applied on at least one side of the carrier, in the form of a thickened dried polymer dispersion, wherein the unthickened dried polymer dispersion comprises: (a) 30.0 to 98.0 wt % of monomeric acrylates; (b) 0 to 50.0 wt % of ethylenically unsaturated comonomers which are not acrylates; (c) 1.0 to 10.0 wt % of tackifier; and (d) 1.0 to 10.0 wt % of kaolin, wherein a rheological additive is added to the polymer dispersion so that the polymer dispersion has a viscosity before drying of 40 to 100 Pa*s at a shear rate of 10/s and a viscosity of 3000 to 8000 Pa*s at a shear rate of 0.01/s.

This application is a continuation application of U.S. Ser. No. 17/036,633, filed on Sep. 29, 2020.

The invention pertains to an adhesive tape for jacketing elongate items such as more particularly cable harnesses in automobiles, and to methods for jacketing.

Adhesive tapes have been used for a considerable time in the industry for producing cable looms. The adhesive tapes are employed for the bundling of a multiplicity of electrical leads prior to installation or in the as-installed state, in order, for example, to reduce—by bandaging—the space taken up by the bundle of leads, and also, in addition, to obtain protective functions such as protection from mechanical and/or thermal stresses.

Common forms of adhesive tapes encompass film or textile carriers, which in general have a coating of pressure-sensitive adhesives on one side. Adhesive tapes for jacketing elongate items are known from, for example, EP 1 848 006 A2, DE 10 2013 213 726 A1, and EP 2 497 805 A1.

Film-backed adhesive tapes achieve a certain protection against ingress of fluid; with light and voluminous adhesive tapes based on thick nonwovens or foams as carriers, damping properties are obtained; when stable, abrasion-resistant carrier materials are used, a protective function with respect to scuffing and rubbing is achieved. Particular protection against impact exposure is achieved through abrasion-resistant woven fabrics with additionally applied coatings.

Besides the conventional vehicles with internal combustion engines, hybrid electric vehicles (HEVs) and electric autos with a battery (battery electric vehicles, BEVs) are increasingly gaining importance.

A hybrid electric vehicle is a vehicle with hybrid drive, namely an electric vehicle which is driven by at least one electrical motor and also a further energy converter and which draws energy not only from its electrical store (rechargeable battery) but also from a fuel which is carried additionally. A fully electric vehicle is driven exclusively by a battery-operated electrical motor and so requires no fossil fuel. The rechargeable battery is charged by way of external power supply units.

In all motor vehicles, the quantity of electrical leads is increasing as a result of increased use of electrical components, while at the same time the space for installation of the harness of leads, particularly in small motor vehicles is becoming even smaller. The construction of electric vehicles and hybrid vehicles, as well, requires a greater number of electrical leads. The use of electrical voltages above 42 V necessitates additional protection of the leads, which is required, beyond the normal service of the vehicle, to ensure protection in specific accident situations as well.

The testing and classifying of adhesive tapes for cable jacketing is accomplished in the automobile industry in accordance with extensive bodies of standards, such as, for example, LV 312-1 “Protective systems for wire harnesses in motor vehicles, adhesive tapes; Test Guideline” (10/2009), as a joint standard of the companies Daimler, Audi, B M W, and Volkswagen, or the Ford specification ES-XU5T-1A303-aa (revised version 09/2009) “Harness Tape Performance Specification”. Below, these standards are referred to in abbreviated form as LV 312 and Ford specification, respectively.

Cable wrapping tapes with film carriers and textile carriers, coated generally on one side with various pressure-sensitive adhesives, are widespread. These cable wrapping tapes are required to meet four main requirements:
a. Ease of unwind:
   The product present in roll form must be easy to unwind, for easy working.
b. Cable compatibility:
   The cable insulation must not become brittle over prolonged time periods through the influence of the adhesive tape in combination with elevated temperature. A distinction is made here according to LV 312 between four temperature classes T1 to T4, corresponding to 80° C. (also called temperature class A), 105° C. (also called temperature class B (105)), 125° C. (also called temperature class C), and 150° C. (also called temperature class D), which the wrapped cables are required to withstand for 3000 h without embrittlement. It is self-evident that temperature classes T3 and T4 place higher demands on the adhesive tape than the lower classes T1 and T2. Assignment to T1 to T4 is decided not only by the cable insulation material but also by the pressure-sensitive adhesive and type of carrier.
c. Chemical compatibility and/or compatibility with media in the engine compartment.
d. High peel adhesion
   The peel adhesion must be sufficient in the event of flexural stress on uneven, nonuniform substrates such as cable runs, convoluted tubes, and branches. Other factors are flexural and tensile stresses in the course of production, installation, and subsequent use within the engine compartment of an automobile, or else in the vehicle body, with continual flexural stress when doors are opened.

Since the end of the adhesive tape is bonded ideally to its own reverse face, there must be good instantaneous peel adhesion (tack) to this substrate, so that there is no flagging of the adhesive tape at the start. In order to ensure a flagging-free product durably, the anchoring on the substrate and the internal strength of the adhesive must both be such that the adhesive bond holds even under the influence of tension (tensile and flexural stressing). In the wrapping of a cable loom, the adhesive tape is bonded with from no overlap at all to complete overlap around the cable, the radius of which is generally small, meaning that the adhesive tape is very sharply curved. At the end of a wrapped section, the tape is typically wrapped primarily onto its own reverse face, so that the degree of overlapping is virtually complete, similar to the customary presentation form of an adhesive tape roll, where the adhesive is likewise bonded to its own reverse face. In the event of flagging, static forces act, for example, through the flexural stiffness of the carrier and the wrapping tension, and may result in the open ends of adhesive tape standing up undesirably, similar to the start of automatic unwinding. The flagging resistance, then, is the capacity of the adhesive to resist this static force.

Flagging, in the case of an adhesive tape wrapped around a body, means the tendency of one end of the adhesive tape to stick up. The cause is the combination of holding power by the adhesive, the stiffness of the carrier, and the diameter of the cable loom.

Verifying the flagging resistance of wire harnessing (WH) cable wrapping tapes is done by way of the TFT method (Threshold Flagging Time). The target variable for an outstandingly flagging-free woven fabric product is defined as a limiting value of well above 1000 min TFT, preferably above 2000 min TFT.

The realization of adhesive tapes which are easy to unwind but at the same time retain good technical adhesive properties represents a major challenge, since the two properties appear to be mutually exclusive. Indeed, the essential criteria in the case of single-sidedly bonding cable wrapping tapes, namely adapted unwind force and sufficiently high peel adhesive, go very much against one another. While good peel adhesion values and an associated low flagging potential require good flow-on and anchoring behavior on the part of the pressure-sensitive adhesive, these criteria tend to be a hindrance to trouble-free unwind performance.

Since in the case of textile carrier materials a reduction in the unwind force using release agents can be realized only at high cost, the plies of adhesive tape are wound directly onto one another, with the adhesive bonding to the reverse face of the ply of tape beneath it. In order to ensure unwind without residues of adhesive on the reverse face of the carrier, the requirements in terms of a balance between cohesion and adhesion are extremely demanding.

For example, cable wrapping tapes with pressure-sensitive adhesives based on natural rubber usually exhibit good flagging resistance, but have an unwind force which increases over the storage period, and also in the case of increasing temperatures. Furthermore, these tapes need only be lower temperature classes for cable compatibility.

WO 2006/015816 A1 discloses pressure-sensitive adhesives based on synthetic rubber with photoinitiators. EP 1 431 360 A2 discloses adhesive tapes which can be wound onto themselves, comprising a thermally consolidated nonwoven with a basis weight of 10 to 50 g/m² and UV-crosslinked acrylate adhesive. Also known are woven fabric adhesive tapes which are based on a crosslinked acrylate hotmelt, usually on an all-acrylate system, and are assigned according to LV 312 to the temperature class D (150° C.). These tapes exhibit low adhesive anchoring and result in transfer of adhesive on smooth carrier surfaces. Also known are woven fabric adhesive tapes which are based on an acrylate dispersion and are assigned according to LV 312 to the temperature class D (150° C.). Likewise known are nonwoven adhesive tapes which are based on a crosslinked acrylate hotmelt, usually an all-acrylate system, and which are assigned according to LV 312 to the temperature class C (125° C.). All woven fabric products here possess the same adhesive, which is adjusted to the particular requirements through coat weight and UV crosslinking. A disadvantage in the context of their application to the cable loom are the markedly upstanding tape ends, when these standard-range adhesive tapes are mounted on critical wrappings such as branches, transitions, small diameters, etc. While the level of their unwind force can be controlled well by means of the selected coat weight and, in particular, UV crosslinking, this nevertheless entails the unwanted side effects of significantly decreasing peel adhesions and an incalculable risk of flagging. Moreover, acrylate hotmelt adhesives can be blended, for incorporation of resins or fillers, only under more difficult conditions. The use of fillers in the context of adhesive design is known against the background of a cost saving.

The cable insulation must not become brittle as a result of the effect of the adhesive tape in combination with elevated temperature over a prolonged period of time. A distinction is made here in accordance with LV 312, among others, between four temperature classes T1 to T4, corresponding to 80° C. (also called temperature class A), 105° C. (also called temperature class B(105)), 125° C. (also called temperature class C), and 150° C. (also called temperature class D), which the wrapped cables are required to withstand for 3000 h without embrittlement. It is self-evident that temperature classes T3 and T4 place higher demands on the adhesive tape than the lower classes T1 and T2. Assignment to T1 to T4 is decided not only by the cable insulation material but also by pressure-sensitive adhesive and type of carrier.

The realization of easy-to-unwind adhesive tapes (for cable bandaging) which at the same time retain good technical adhesive properties poses a major challenge, since the two properties appear to be mutually exclusive—the essential criteria in the case of single-sidedly bonding cable wrapping tapes, namely adapted unwind force and sufficiently high peel adhesion, go very much against one another. While good peel adhesion values and an associated low flagging potential require good flow-on and anchoring behavior on the part of the pressure-sensitive adhesive, these criteria tend to be a hindrance to trouble-free unwind performance.

Plasticizers are added to plastics such as cable jackets or cable sheaths in order to provide them with long-term flexibility, suppleness, and elasticity. Plasticizers may be low-volatility resins, esters, or oils.

The function of the plasticizers is to shift the thermoplastic range toward lower temperatures. Examples of known plasticizers include DOP (dioctyl phthalate, di-2-ethylhexyl phthalate), DINP (diisononyl phthalate), TOTM (trioctyl trimellitate) or DIDP (diisodecyl phthalate).

Frequently employed are external plasticizers, which are not bound covalently into the polymer but instead interact with the polymer via polar groups, in order to enable mobility of the polymeric chains; examples are diethylhexyl phthalate (DEHP) and dioctyl phthalate (DOP) as plasticizers for PVC and elastomers. Further plasticizers include citric acid-based plasticizers such as triethyl citrate, or adipic acid-based plasticizers such as diethylhexyl adipate and diethyloctyl adipate. The diffusion of these external plasticizers from the plastics of the cable insulations can be reduced significantly by the adhesive tapes of the invention with pressure-sensitive adhesives.

Internal plasticizers are understood to be those which are present during the copolymerization and are copolymerized, and are subsequently unable to diffuse out of the polymer.

Acrylate adhesives generally have a very high affinity for the usual PVC plasticizers, resulting in a strong tendency toward migration of the so-called monomer plasticizers such as DINP, DIDP or TOTM, for example. It is also known that when PVC-insulated cable leads are used, there is severe plasticizer migration over time, and especially under temperature load, up to the point where an equilibrium is established between insulation and adhesive tape or adhesive. The result is an unwanted embrittlement of the cable sheathing/cable insulation. In combination with aging effects (oxidation, loss of plasticizer to the surroundings, breakdown, mechanical loads, etc.), increased plasticizer migration results in premature failure of the cable insulation through embrittlement. For plasticized PVC, this is also known as the “brittle gap”.

For the purpose of reducing or preventing plasticizer migration there are primarily two known measures: thus a) the equilibrium may be made the focus, with plasticizer being added to the adhesive during the production process itself. This, however, frequently leads to far-reaching changes in the technical adhesive properties, up to the point of complete cohesive failure of the adhesive. Alternatively b) in order to erect an effective barrier, close-meshed crosslinking of the adhesive can be undertaken, albeit it again possibly with dramatic consequences for the technical adhesive aspects, or else finely disperse fillers can be used that are capable of constructing a network.

The object on which the present invention is based is that of providing an adhesive tape with unwind forces which are adjustable over a relatively broad spectrum, i.e., which features ease of unwind; which exhibits high cable compatibility over all of the stated temperature classes for applications in the segment of cable bandaging (wire harnessing (WH) applications), namely an excellent compatibility with all usual cable insulation systems, especially according to the reference spectrum of cables in LV 312; and which enables the particularly simple, inexpensive, and rapid jacketing of elongated items such as cable looms in automobiles.

This object is achieved by means of an adhesive tape as recorded in the main claim. The dependent claims relate to advantageous developments of the adhesive tape and to methods for employing the adhesive tape.

The invention relates accordingly to an adhesive tape in particular for wrapping cables, comprising a textile carrier and a pressure-sensitive adhesive, applied on at least one side of the carrier, in the form of a thickened dried polymer dispersion, where the unthickened dried polymer dispersion comprises:
(a) 30.0 to 98.0 wt % of monomeric acrylates;
(b) 0 to 50.0 wt % of ethylenically unsaturated comonomers which are not acrylates;
(c) 1.0 to 10.0 wt % of tackifier; and
(d) 1.0 to 10.0 wt % of kaolin.

A rheological additive is added to the polymer dispersion so that the polymer dispersion before drying has a viscosity of 40 Pa*s up to 100 Pa*s at a shear rate of 10/s and a viscosity of 3000 Pa*s up to 8000 Pa*s at a shear rate of 0.01/s.

Preferably, the polymer dispersion before drying has a viscosity of 50 Pa*s up to 80 Pa*s at a shear rate of 10/s and a viscosity of 4000 Pa*s up to 6000 Pa*s at a shear rate of 0.01/s.

According to a preferred variant of the invention, the pressure-sensitive adhesive composition contains between 0.1 and 5 parts by weight of thickener based on the mass of the dried polymer dispersion.

Monomeric acrylates are understood presently to be those acrylates in which the acrylate possesses a carbonyl group (C═O) such as, preferably, all monomeric acrylates having an optionally functionalized parent structure C═C—(C═O)—, and so acrylamides are counted among the acrylates, and acrylonitriles are counted among the ethylenically unsaturated comonomers.

The monomeric acrylates are mono-, di- and/or polyfunctional acrylates.

With further preference the ethylenically unsaturated comonomers are selected from ethylene-containing monomers, vinyl-functional monomers, and unsaturated hydrocarbons having 3 to 8 carbon atoms, in relation to the polymers.

The acrylate dispersions, especially aqueous acrylate dispersions, contrast with the acrylate hot melts and solvent-based acrylates in still comprising, to a certain degree, separation of the polymer coils which originate from the individual dispersion beads (see, among other references, BASF-Handbuch Lackiertechnik, Artur Goldschmidt, Hans-Joachim Streitberger, 2002, section 3.1.2.1, FIG. 3.1.5, p. 337 ff.).

In the case of acrylate dispersions, the high gel fraction means that no rational determination of the molecular weight is possible. The high gel fraction results from the chain transfer reactions in the dispersion particles. In the case of emulsion polymerization in particular, the probability of such crosslinking is high, since only growing polymer chains and monomers are present in the dispersion particles, and so this crosslinking is greatly increased relative to solution polymerization. The particular feature of the acrylate dispersions, especially of the aqueous acrylate dispersions, is that this kind of crosslinking in the confined sphere of the dispersion particles produces branched molecules having a high molecular weight.

The high gel content of the acrylate dispersions is also a good descriptor of the situation whereby they can frequently be used without further crosslinking as pressure-sensitive adhesives (PSAs); this contrasts with acrylate hot melts or solvent-based acrylate adhesives, which as a general rule require post crosslinking. Typical acrylate hotmelt compounds have a low gel content of 10%.

In contrast, the polymeric acrylate dispersions used in the PSAs of the invention, especially dried, originally aqueous acrylate dispersions, have a gel content of greater than or equal to 40%, which can be determined via Soxhlet extraction, more particularly of greater than or equal to 45%. Typical acrylate dispersions of the kind employable in the invention are described in DE 10 2011 075 156 A1, DE 10 2011 075 159 A1, DE 10 2011 075 152 A1, and DE 10 2011 075 160 A1. Full reference is made to these specifications in relation to the acrylate dispersions employable in the invention. These acrylate dispersions, moreover, are elucidated in more detail below.

A particular advantage of the PSAs of the invention lies in the simple and economic possibility for individual fine-tuning of the PSA via the quantity of kaolins, and also in the simple and economically individual possibility of fine-tuning the acrylate dispersions to the particular requirements and to the desired carrier material. A second advantage is that, optionally, any crosslinking of the resin-modified acrylate dispersions that may be desired after drying can easily take place in the coating operation from the adhesive side by means of EBC, in order to bring about the optimum of cohesion and adhesion.

An essential advantage which is manifested in the properties of the acrylate dispersions is that the acrylate dispersions, in contrast to hotmelt adhesives and solvent-based adhesives, to a certain degree retain separation of the polymer coils which originate from the individual dispersion beads.

As a result of the possibility through the invention of EBC irradiation, there is a wide-meshed crosslinking within the polymer coils, leading to an increase in the molecular weight within the polymer coils. Advantageously there is virtually no crosslinking between the polymer coils, and so the adhesive remains highly flowable and allows effective wetting of the adhesion base. This phenomenon can be demonstrated by means of rheological studies (such as DMA, dynamic mechanical analysis).

Particular advantages are afforded by the PSAs of the invention by means of very simple blendability with predispersed resins, auxiliaries, fillers, aging inhibitors, etc. It is in fact possible to formulate the PSAs for use in the invention, comprising acrylate dispersions, in such a way that even without additional crosslinking (EBC crosslinking) they afford sufficient cohesion and at the same time can be employed with good values for unwind forces on completed adhesive-tape rolls.

A subject of the invention is an adhesive tape with PSA applied on one side of the carrier with a coat weight of less than or equal to 160 g/m², more particularly less than or equal to 120 g/m², preferably less than or equal to 90 g/m², more preferably less than or equal to 80 g/m², preferentially less than or equal to 70 g/m² and, in alternatives, also less than or equal to 60 g/m² and less than or equal to 50 g/m², in each case with a tolerance of plus/minus 2 g/m², preferably with plus/minus 1 g/m².

A further subject of the invention are adhesive tapes having a carrier and a PSA applied on one side of the carrier, the carrier being impregnated with an additional acrylate dispersion which is not counted in the coat weight of the PSA. The impregnation may be applied with a coat weight of less than or equal to 30 g/m², more particularly less than or equal to 25 g/m², preferably less than or equal to 20 g/m², more preferably less than or equal to 10 g/m², in each case with a tolerance of plus/minus 5 g/m²,

A feature of the acrylate dispersions used for the impregnation is that in the dried state they preferably have only very slight or no pressure-sensitive adhesive properties. Therefore, acrylate dispersions or else, optionally, polyurethane, rubber-based on SBR impregnations can be used which in the dried state preferably have only very slight pressure-sensitive adhesive properties, or none. This prevents blocking of the plies on the bale. Optionally it is possible to use acrylate dispersions of the invention having slight pressure-sensitive properties or none, in other words without resins.

Preferred carriers are those which do not have impregnation, in particular with an acrylate dispersion.

According to preferred embodiments, the adhesive tape, especially for wrapping cables, comprises a carrier and a pressure-sensitive adhesive which is applied on at least one side of the carrier and which comprises a dried acrylate dispersion, and the acrylate dispersion, more particularly the undried acrylate dispersion, comprises polymers which are constructed of or obtainable from
(I) a) monomeric acrylates at 30.0 to 88.0 wt % and 0.0 to 2.0 wt % of a di- or polyfunctional monomer, more preferably 0.0 to 1.0 wt % of a di- or polyfunctional monomer,
   b) ethylenically unsaturated comonomers at 10.0 to 48.0 wt %, selected from at least one ethylenically unsaturated monofunctional monomer or
      a mixture of these and of one or more ethylenically unsaturated monomers having an acid or acid anhydride function, the latter making up 0.0 to 10.0 wt % of the wt % at most,
   c) 1.0 to 10.0 wt % of tackifier
   d) 1.0 to 10.0 wt % of kaolin
or
(II) a) monomeric acrylates at 68.0 to 97.0 wt % and 0.0 to 2.0 wt % of a di- or polyfunctional monomer, more preferably 0.0 to 1.0 wt % of a di- or polyfunctional monomer,
   b) ethylenically unsaturated comonomers at 1.0 to 10.0 wt %, selected from at least one ethylenically unsaturated monofunctional monomer or
      a mixture of these and of one or more ethylenically unsaturated monomers having an acid or acid anhydride function, the latter making up 0.0 to 10.0 wt % of the wt % at most,
   c) 1.0 to 10.0 wt % of tackifier
   d) 1.0 to 10.0 wt % of kaolin,
the acrylate dispersion being prepared by reacting the monomers as per (I) and/or (II) in an emulsion polymerization.

According to further preferred embodiments, the acrylate dispersion comprises polymers which are constructed of or obtainable from a) monomeric acrylates selected from alkyl (meth)acrylates such as n-butyl acrylate and 2-ethylhexyl acrylate, preferably C₁ to C₂₀ alkyl (meth)acrylates, C₁ to C₁₀ hydroxyalkyl (meth)acrylates such as especially hydroxyethyl or hydroxypropyl (meth)acrylate, acid amides such as acrylamide or methacrylamide, and also mixtures of two or more of the monomers, and of or from b) ethylenically unsaturated comonomers selected from ethylene, aromatic vinyl monomers such as styrene, α-methylstyrene, and vinyltoluene, divinylbenzene, vinyl esters of carboxylic acids containing up to 20 carbon atoms, such as vinyl laurate, vinyl ethers of alcohols containing up to 10 carbon atoms, such as vinyl methyl ether or vinyl isobutyl ether, vinyl halides such as vinyl chloride or vinylidene dichloride, itaconic acid, maleic acid, fumaric acid and/or maleic anhydride, acrylonitrile and/or methacrylonitrile, unsaturated hydrocarbons having 3 to 8 carbon atoms such as propene, butadiene, isoprene, 1-hexene or 1-octene, and also mixtures of two or more comonomers.

The ethylenically unsaturated monomers having an acid or acid anhydride function are preferably selected from the group of acrylic acid, methacrylic acid, itaconic acid, maleic acid, fumaric acid and/or maleic anhydride.

According to further preferred embodiments, the acrylate dispersion comprises polymers which are constructed of or obtainable from a) monomeric acrylates selected from acrylic acid or methacrylic acid, n-butyl acrylate, ethyl acrylate such as 2-ethylhexyl acrylate, and also mixtures of two or more monomers, and di- or polyfunctional monomers selected from alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, and triacrylates such as trimethylolpropane triacrylate, and tetraacrylates such as pentaerythritol tetraacrylate, and also, optionally, in combination with the monomeric comonomers stated under b).

Typical particle sizes of the dispersed polymers of the invention range from 20 nm up to 10 μm.

The polymer dispersion is prepared by the method of emulsion polymerization of the stated components. Descriptions of this method can be found for example in “Emulsion Polymerization and Emulsion Polymers” by Peter A. Lovell and Mohamed S. El-Aasser—Wiley-VCH 1997— ISBN 0-471-96746-7 or in EP 1 378 527 B1.

In the polymerization it cannot be ruled out that not all of the monomers are converted into polymers. In this context it is obvious that the residual monomer content ought to be as small as possible.

Adhesives provided with preference comprise the polymer dispersion with a residual monomer content of less than or equal to 1 wt %, more particularly less than or equal to wt % (based on the mass of the dried polymer dispersion).

According to one preferred embodiment of the invention, the PSA has been admixed with crosslinkers—that is, with compounds capable of crosslinking.

As used here, the term “crosslinker” stands for chemical compounds which are capable of joining molecular chains to one another, allowing the two-dimensional structures to develop, by forming intermolecular bridges, into three-dimensionally crosslinked structures.

Crosslinkers are those compounds—especially di- or polyfunctional, usually of low molecular mass—that under the selected crosslinking conditions are able to react with suitable—especially functional—groups of the polymers to be crosslinked, and so two or more polymers or polymer sites link to one another (form “bridges”) and so create a network of the polymer or polymers to be crosslinked. This generally results in an increase in cohesion.

Typical examples of crosslinkers are chemical compounds which, within the molecule or at the two ends of the molecule, have two or more identical or different functional groups and, consequently, are able to crosslink molecules with the same or else different structures with one another. A crosslinker, moreover, is able to react with the reactive monomer or reactive resin, as defined above, without an accompanying polymerization in the true sense. The reason is that, in contrast to the activator, as described above, a crosslinker can be incorporated into the polymer network.

Besides the acrylate polymers recited, the PSA may be admixed not only with any residual monomers present but also, additionally, with adjuvants such as light stabilizers or aging inhibitors, in the amounts stated below.

In particular, no further polymers such as elastomers are included in the PSA; in other words, the polymers of the PSA consist only of the monomers in the specified proportions.

The adhesive is a pressure-sensitive adhesive (PSA) in other words an adhesive which even under relatively weak applied pressure allows durable bonding to virtually all substrates and which after use can be detached from the substrate again substantially without residue. A PSA has a permanently pressure-sensitive adhesive effect at room temperature, in other words possessing sufficiently low viscosity and a high tack, and so the surface of the bonding substrate in question is wetted even with low applied pressure. The bondability of the adhesive derives from its adhesive properties, and the redetachability from its cohesive properties.

In order to acquire pressure-sensitive adhesive properties, the adhesive must be above its glass transition temperature at the processing temperature, so as to have viscoelastic properties. Because cable harness wrapping takes place at normal ambient temperature (approximately between 15° C. to 25° C.), the glass transition temperature of the PSA formulation is preferably below +15° C. (determined by DSC (Differential Scanning Calorimetry) in accordance with DIN 53765 at a heating rate of 10 K/min).

The glass transition temperature of the acrylate polymers can be estimated, in accordance with the equation of Fox, from the glass transition temperatures of the homopolymers and from their relative proportions.

In order to obtain polymers, for example pressure-sensitive adhesives or heat-sealing compounds, having desired glass transition temperatures, the quantitative composition of the monomer mixture is advantageously selected such that an equation (E1) in analogy to the Fox equation (cf. T. G. Fox, Bull. Am. Phys. Soc. 1956, 1, 123) produces the desired TG for the polymer.

$$\frac{1}{{T}_{G}} = {\sum }_{n} \frac{{w}_{n}}{{T}_{G , n}} \qquad ( E1 )$$

The possible addition of tackifiers automatically raises the glass transition temperature, depending on amount added, compatibility, and softening temperature, by around 5 to 40 K.

Acrylate copolymers having a glass transition temperature of at most 0° C. are therefore preferred.

The polymers of the invention have a peel adhesion on steel of at least 1.0 N/cm according to ASTM D3330 (for an adhesive coat weight of 30 g/m² on a 23 μm polyester film carrier).

A “tackifier resin” is understood, in accordance with the general understanding of the skilled person, to refer to an oligomeric or polymeric resin which raises the autoadhesion (the tack, the inherent adhesiveness) of the PSA by comparison with an otherwise identical PSA that contains no tackifier resin.

The use of tackifiers for boosting the peel adhesion values of PSAs is known in principle. This effect also comes about if the adhesive is admixed with between 1 to 10 wt %, preferably 3 to 7 wt %, more preferably 4 to 6 wt % of tackifiers.

These also contribute to the improved flagging resistance.

Preferred tackifier resins are those having a softening point of more than 100° C. according to ASTM E28-99 (2009).

Suitability as tackifiers, also referred to as tackifier resins, is possessed in principle by all known classes of compound. Tackifiers are, for example, hydrocarbon resins (for example, polymers based on unsaturated C₅ or C₉ monomers), terpene phenolic resins, polyterpene resins based on raw materials such as, for example, α- or β-pinene, aromatic resins such as coumarone-indene resins or resins based on styrene or α-methylstyrene such as rosin and its derivatives, examples being disproportionated, dimerized or esterified rosin, for example reaction products with glycol, glycerol or pentaerythritol, to name but a few. Preferred resins are those without readily oxidizable double bonds, such as terpene phenolic resins, aromatic resins and, very preferably, resins produced by hydrogenation, such as, for example, hydrogenated aromatic resins, hydrogenated polycyclopentadiene resins, hydrogenated rosin derivatives or hydrogenated polyterpene resins.

Preferred resins are those based on terpene phenols and rosin esters.

Particularly preferred are resins based on terpene phenols and rosin esters having a softening point of more than 100° C. according to ASTM E28-99 (2009). The resins are usefully employed in dispersion form. In that way they can easily be mixed in finely divided form with the polymer dispersion.

For further improvement of the cable compatibility, the adhesive formulation may optionally have been blended with light stabilizers or with primary and/or secondary aging inhibitors. Aging inhibitors used may be products based on sterically hindered phenols, phosphites, thiosynergists, sterically hindered amines or UV absorbers.

Preference is given to using primary antioxidants such as, for example, Irganox 1010 or Irganox 254, alone or in combination with secondary antioxidants such as, for example, Irgafos TNPP or Irgafos 168.

The aging inhibitors here may be used in any desired combination with one another, with particularly good aging inhibition being displayed by mixtures of primary and secondary antioxidants in combination with light stabilizers such as Tinuvin 213, for example.

The aging inhibitors in which a primary antioxidant is united with a secondary antioxidant in one molecule have proven especially advantageous. These aging inhibitors comprise cresol derivatives whose aromatic ring is substituted by thioalkyl chains at two arbitrary, different locations, preferably in ortho- and meta-position relative to the OH group, it also being possible for the sulfur atom to be joined to the aromatic ring of the cresol building block via one or more alkyl chains. The number of carbon atoms between the aromatic moiety and the sulfur atom may be between 1 and 10, preferably between 1 and 4. The number of carbon atoms in the alkyl side chain may be between 1 and 25, preferably between 6 and 16. Particularly preferred in this context are compounds of the 4,6-bis(dodecylthiomethyl)-o-cresol, 4,6-bis(undecylthiomethyl)-o-cresol, 4,6-bis(decylthiomethyl)-o-cresol 4,6-bis(nonylthiomethyl)-o-cresol or 4,6-bis(octylthiomethyl)-o-cresol type. Aging inhibitors of these kinds are available for example from Ciba Geigy under the name Irganox 1726 or Irganox 1520.

The amount of the aging inhibitor or aging inhibitor package added ought to be situated within a range between 0.1 and 10 parts by weight, based on the mass of the dried polymer dispersion, preferably in a range between 0.2 and 5 parts by weight, based on the mass of the dried polymer dispersion, more preferably in a range between 0.5 and 3 parts by weight, based on the mass of the dried polymer dispersion.

Preference is given to a presentation form of a dispersion for particularly simple miscibility with the adhesive dispersion. Alternatively it is also possible for liquid aging inhibitors to be incorporated directly into the dispersion, in which case the step of incorporation ought to be followed by a standing time of a number of hours, to allow the homogeneous distribution of the aging inhibitor in the dispersion or its acceptance into the dispersion particles. A further alternative is the addition of an organic solution of the aging inhibitors to the dispersion. Suitable concentrations lie in the range from 0.1 up to 8, preferably 0.1 to 5, parts by weight, based on the mass of the dried polymer dispersion.

To improve the processing properties, the adhesive formulation may further have been blended with customary process auxiliaries such as defoamers, deaerating agents, wetting agents, or flow control agents. Suitable concentrations are in the range from 0.1 up to 5 parts by weight, based on the mass of the dried polymer dispersion.

Phyllosilicates, or alternative sheet silicates or layered silicates, are known for use as ion exchangers. Known phyllosilicates are clay minerals such as montmorillonite, nontronite, hectorite, saponite, sauconite, beidellite, allevardite, illite, halloysite, attapulgite and/or sepiolite, and also disteardimonium hectorite. Hectorites are M_{0.3}⁺(Mg_{2.7}Li_{0.3})[Si₄O₁₀(OH)₂], M⁺ usually=Na⁺, monoclinic clay mineral belonging to the smectites and similar to montmorillonite.

According to manufacturers, the full activity of unmodified phyllosilicates may be developed by activation with polar additives and high shearing forces (for example, product information on Tixogel® VP-V (Quaternium-90 Bentonite) from Rockwood Additives Ltd. or on Bentone® 38 (organic derivative of a magnesium phyllosilicate (hectorite) from Rheox Inc.).

This activation of the phyllosilicates, namely conversion into a swellable form, is accomplished by treating the phyllosilicates with a polar liquid and high shearing forces. The resultant phyllosilicates are considered to be modified phyllosilicates. Modified phyllosilicates are likewise also known under the name Laponite®, Optigel®, Laponite SL 25®, Laponite S482®, Laponite EP®, Laponite RDS®, Optigel CK® from Rockwood.

Kaolin, also referred to as porcelain earth, porcelain clay, white clay earth, china clay or, in pharmacy, as bolus alba or pipe earth, is a fine, iron-free, white mineral whose main constituent is kaolinite, a weathering product of feldspar. Further constituents are various other clay minerals and undecomposed feldspar particles.

Kaolin is used primarily in the production of paper and for preparing porcelain. In addition, bolus alba is used as one constituent of some powder bases, and is also added to comestibles.

Kaolins are the two-layer silicates. On account of their high layer charge, they are not swellable, and are therefore present as relatively coarse filler particles in the adhesive.

Depending on the amount in which the kaolins are added to the PSA, therefore, plasticizer migration can be slowed down or virtually stopped, and the slipping of the plasticizer content into the range of the “brittle gap” in PVC, especially in PVC cable insulation, can be avoided. The kaolins used in the PSAs of the invention are added at preferably 3 to 7 wt %, more preferably at 5 to 6 wt %.

Kaolin may be added in solid form or likewise as an aqueous dispersion. Preference is given to ultrafine grades (HG 90 or Amazon Premium Slurry).

The shear viscosities of commercial dispersions are generally too low. Normally rheological additives, also called thickeners, are used in order to attain the necessary shear viscosities.

A fundamental distinction is made here between organic and inorganic rheology additives. The organic thickeners divide in turn into two essential modes of action: (i) the thickening of the aqueous phase, i.e., nonassociating, and (ii) association between thickener molecule and particles, in part with incorporation of the stabilizers (emulsifiers). Representatives of the first (i) group of compounds are water-soluble polyacrylic acids and polycoacrylic acids, which in the basic medium form polyelectrolytes of high hydrodynamic volume. The skilled person also refers to these for short as ASEs (alkali-swellable emulsions). They are notable for high resting shear viscosities and strong shear thinning. Another class of compounds are the modified polysaccharides, especially cellulose ethers such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, 2-hydroxybutylmethylcellulose. Additionally included in this class of compounds are less widely used polysaccharides such as starch derivatives and specific polyethers.

The activity group of the (ii) associative thickeners are, in principle, block copolymers having a water-soluble middle block and hydrophobic end blocks, the end blocks interacting with the particles or with themselves and so forming a three-dimensional network with incorporation of the particles. Typical representatives are familiar to the skilled person as HASEs (hydrophobically modified alkali-swellable emulsions), HEUR (hydrophobically modified ethyleneoxide urethanes) or HMHEC (hydrophobically modified hydroxyethyl celluloses). In the case of the HASE thickeners, the middle block is an ASE, and the end blocks are usually long, hydrophobic alkyl chains coupled on via polyethylene oxide bridges. In the case of the HEURs, the water-soluble middle block is a polyurethane, and in the HMHEC it is a 2-hydroxyethylcellulose. The nonionic HEURs and HMHECs in particular are largely insensitive to pH.

Depending on structure, the associative thickeners result in more or less Newtonian (shear rate-independent) or pseudoplastic (shear-liquifying) flow behavior. Occasionally they also exhibit a thixotropic character, meaning that the viscosity is subject not only to dependency on shearing force but also to dependency on time.

The inorganic thickeners are usually phyllosilicates of natural or synthetic origin, examples being hectorites and smectites. On contact with water, the individual layers part from one another. At rest, as a result of different charges on surfaces and edges of the platelets, they form a space-filling house-of-cards structure, resulting in high resting shear viscosities through to yield points. On shearing, the house-of-cards structure collapses and a marked drop in the shear viscosity is observed. Depending on charge, concentration, and geometrical dimensions of the platelets, the development of structure may take some time, and so with inorganic thickeners of this kind it is also possible to obtain thixotropy.

The thickeners can in some cases be stirred directly into the adhesive dispersion, or in some cases are predispersed or prediluted advantageously in water beforehand. Typical use concentrations are 0.1 to 5 wt %, based on the mass of the dried polymer dispersion. Suppliers of thickeners are, for example, OMG Borchers, Omya, Byk Chemie, Dow Chemical Company, Evonik, Rockwood, or Munzing Chemie.

As a result of the addition, viscosities arising preferably for the polymer dispersion, are from Pa*s to 120 Pa*s at a shear rate of 10 s⁻¹, and from 1200 Pa*s to 8000 Pa*s at a shear rate of 0.01 s⁻¹.

Fillers (reinforcing or nonreinforcing) such as silicon dioxides (spherical, acicular, platelet-shaped or irregular like the fumed silicas), glass in the form of solid or hollow beads, microballoons, calcium carbonates, zinc oxides, titanium dioxides, aluminum oxides or aluminum oxide hydroxides may serve for fine-tuning of the processing properties and also of the technical adhesive properties. Suitable concentrations are in the range from 0.1 up to 20 parts by weight, based on the mass of the dried polymer dispersion.

In one preferred embodiment the adhesive formulation of the invention has a peel adhesion on steel of at least 2.0 N/cm according to ASTM D3330 (for an adhesive coat weight of around 100 g/m² on a woven polyester fabric carrier).

With particular preference the PSA has a peel adhesion of greater than or equal to, or at least, 2.5 N/cm (for a PSA coat weight of 90 g/m² on woven polyester fabric carrier, preferably also even at 80 g/m², more preferably at 70 g/m², on a woven polyester fabric carrier). With particular preference the PSA according to ASTM D3330 has a peel adhesion on steel of at least 5.0 N/cm (for a PSA coat weight of 90 g/m² on a woven polyester fabric carrier).

Likewise a subject of the invention is an adhesive tape with a PSA which according to LV 312 preferably has an unwind force of 3.0 N/cm to 9.0 N/cm at 30 m/min, more particularly of 4.0 N/cm to 6.0 N/cm at 30 m/min.

The unwind force of the adhesive tapes of the invention can be set in a targeted and precise way. This is of particular interest for adhesive cable bandaging tapes for manual or machine application. The target variable is less than 6.0 N/cm at 30 m/min for machine-applied adhesive cable bandaging tapes; for their manual counterparts, the figures are 4.0 N/cm to 6.0 N/cm.

Suitable carriers include in principle all carrier materials, preferably textile carriers and more preferably woven fabrics, more particular woven polyester fabrics.

As carrier material for the adhesive tape it is possible to use all known textile carriers such as knitted fabrics, scrims, tapes, braids, tufted textiles, felts, woven fabrics (encompassing plain weave, twill and satin weave), knitted fabrics (encompassing warp knits and other knits) or nonwoven webs, the term “nonwoven web” comprehending at least sheetlike textile structures as per EN 29092 (1988) and also stitch bonded webs and similar systems. Particularly advantageous is an adhesive tape wherein a woven, nonwoven, or knitted fabric is used as the carrier. Carriers of these kinds are described for example in WO 2015/004190 A1.

It is likewise possible to use woven and knitted spacer fabrics with lamination.

Spacer fabrics of these kinds are disclosed in EP 0 071 212 B1. Spacer fabrics are matlike layer structures comprising a cover layer of a fiber or filament web, an underlayer, and individual retaining fibers or bundles of such fibers between these layers, these fibers being distributed over the area of the layer structure, being needled through the particle layer, and joining the cover layer and the underlayer to one another. As an additional although not mandatory feature, the retaining fibers in accordance with EP 0 071 212 B1 contain particles of inert minerals, such as sand, gravel, or the like, for example.

The retaining fibers needled through the particle layer hold the cover layer and the underlayer at a distance from one another and are joined to the cover layer and the underlayer.

Nonwovens contemplated include, in particular, consolidated staple fiber webs, but also filament webs, meltblown webs and spunbonded webs, which generally require additional consolidation. Possible consolidation methods known for webs include mechanical, thermal, and chemical consolidation. If with mechanical consolidations the fibers are held together purely mechanically, usually by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds can be restricted exclusively, or at least predominantly, to fiber nodal points, so that a stable, three-dimensional network is formed while nevertheless retaining the relatively loose, open structure in the web.

Webs which have proved particularly advantageous are those consolidated in particular by overstitching with separate threads or by interlooping.

Consolidated webs of this kind are produced for example on stitchbonding machines of the “Malimo” type from Karl Mayer, formerly Malimo, and can be obtained from companies including Techtex GmbH. A Mali fleece is characterized in that a cross-made web is consolidated by the formation of loops from fibers of the web.

The carrier used may also be a web of the Kunit or Multiknit type. A Kunit web is characterized in that it originates from the processing of a longitudinally oriented fiber web to form a sheetlike structure which has loops on one side and has loop feet or pile fiber folds on the other side, but possesses neither threads nor prefabricated sheetlike structures. A web of this kind as well has been produced by relatively long time, for example on stitchbonding machines of the “Malimo” type from Karl Mayer. A further characterizing feature of this web is that, as a longitudinal-fiber web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fiber nonwovens produced by the Kunit process. In the end product, both top sides of the nonwovens are shaped by means of interlooped fibers to form a closed surface, and are joined to one another by fibers which stand almost perpendicularly. An additional possibility is to introduce further needleable sheetlike structures and/or scatterable media.

Finally, stitchbonded webs as an intermediate are also suitable for forming a covering of the invention and an adhesive tape of the invention. A stitchbonded web is formed from a nonwoven material having a large number of stitches extending parallel to one another. These stitches are brought about by the stitching-in or stitchbonding of continuous textile threads. For this type of web (also known as Maliwatt), stitchbonding machines of the “Malimo” type from Karl Mayer are known.

Also particularly suitable are needlefelt webs. In the needlefelt web, a tuft of fibers is made into a sheetlike structure by means of needles provided with barbs. By alternate introduction and withdrawal of the needles, the material is consolidated on a needle bar, with the individual fibers interlooping to form a firm sheetlike structure. The number and configuration of the needling points (needle shape, penetration depth, double-sided needling) determine the thickness and strength of the fiber structures, which are in general lightweight, air-permeable, and elastic.

Additionally particularly advantageous is a staple fiber web which is mechanically preconsolidated in the first step or is a wetlaid web laid hydrodynamically, in which between 2 wt % and 50 wt % of the fibers of the web are fusible fibers, more particularly between wt % and 40 wt % of the fibers of the web.

A web of this kind is characterized in that the fibers are laid wet or, for example, a staple fiber web is preconsolidated by the formation of loops from fibers of the web by needling, stitching, air-jet and/or water-jet treatment.

In a second step, thermofixing takes place, with the strength of the web being increased again by the melting, or partial melting, of the fusible fibers.

For the utilization of nonwovens in the invention, the adhesive consolidation of mechanically preconsolidated or wetlaid webs is of particular interest, it being possible for said consolidation to take place via the addition of binder in solid, liquid, foamed or pastelike form. A great diversity of theoretical presentation forms is possible: for example, solid binders as powder for trickling in; as a sheet or as a mesh; or in the form of binding fibers. Liquid binders can be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually dispersions of thermoplastics such as acrylates, vinyl acetates, polyurethanes, styrene-butadiene systems, PVC, and the like, and also copolymers thereof.

Normally the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for producing specific changes in the surface properties.

Such a procedure not only is sparing in its use of binder but also greatly reduces the energy requirement for drying. Since no squeeze rolls are required and the dispersions remain predominantly in the upper region of the nonwoven, unwanted hardening and stiffening of the web can be largely prevented.

For sufficient adhesive consolidation of the web carrier, the addition of binder in the order of magnitude of 1% to 50%, more particularly 3% to 20%, based on the weight of the fiber web, is generally required.

The binder may be added as early as during the manufacture of the web, in the course of mechanical preconsolidation, or else in a separate process step, which may be carried out in-line or off-line. After the addition of binder, it is necessary temporarily to generate a condition for the binder in which the binder becomes adhesive and adhesively connects the fibers—this may be achieved during the drying, for example, of dispersions, or else by means of heating, with further possibilities for variation existing by way of whole-surface or partial application of pressure. The binder may be activated in known drying channels, given an appropriate selection of binder, or else by means of infrared radiation, UV radiation, ultrasound, high-frequency radiation, or the like. For the subsequent end use it is sensible, though not absolutely necessary, for the binder to have lost its tack following the end of the web production process. It is advantageous that, as a result of thermal treatment, volatile components such as fiber assistants are removed, giving a web having favorable fogging values, so that when a low-fogging adhesive is used, it is possible to produce an adhesive tape having particularly favorable fogging values; accordingly, the covering as well has a very low fogging value.

By fogging (see DN 75201 A) is meant the effect where, under unfavorable conditions, compounds of low molecular mass may outgas from the adhesive tapes and condense on cold parts. As a result of this it is possible, for example, for the view through the windshield to be adversely affected.

A further special form of adhesive consolidation involves activating the binder by partial dissolution or partial swelling. In this case it is also possible in principle for the fibers themselves, or admixed specialty fibers, to take over the function of the binder. Since, however, such solvents are objectionable on environmental grounds, and/or are problematic in their handling, for the majority of polymeric fibers, this process is not often employed.

Advantageously and at least in regions, the carrier may have a single-sidedly or double-sidedly polished surface, preferably in each case a surface polished over the whole area. The polished surface may be chintzed, as elucidated in detail in EP 1 448 744 A1, for example.

Furthermore, the carrier may be compacted by calendering on a roll mill. The two rollers preferably run in opposite directions and at the same peripheral speed, causing the carrier to be pressed and compacted.

If there is a difference in the peripheral speed of the rollers, then the carrier is additionally polished.

The carrier is preferably a woven fabric, more preferably a woven polyester fabric.

Particular preference is given to fabrics having the following construction:
the thread count in the warp is 10 to 60/cm;
the thread count in the weft is 10 to 40/cm;
the warp threads possess a yarn weight of between 40 and 400 dtex, more particularly between 44 and 330 dtex, very preferably of 167 dtex; and
the weft threads possess a yarn weight of between 40 and 660 dtex, more particularly between 44 and 400 dtex, very preferably of 167 dtex.

According to a further advantageous embodiment of the invention, the thread count in the warp is 40 to 50/cm, preferably 44/cm.

According to a further advantageous embodiment of the invention, the thread count in the weft is 18 to 22/cm, preferably 20/cm.

According to a further advantageous embodiment of the invention, the woven fabric is a woven polyester fabric. Other options are woven polyamide, woven viscose and/or a woven blend fabric made from the stated materials.

With further preference the thickness of the woven fabric is at most 300 μm, more preferably 170 to 230 μm, very preferably 190 to 210 μm.

The carrier, according to a further advantageous embodiment of the invention, has a basis weight of up to 200 g/m², preferably 100 to 150 g/m².

Starting materials for the carrier material for the adhesive tape are more particularly (manmade) fibers (staple fiber or continuous filament) made from synthetic polymers, also called synthetic fibers, of polyester, polyamide, polyimide, aramid, polyolefin, polyacrylonitrile or glass, (manmade) fibers made from natural polymers such as cellulosic fibers (viscose, modal, lyocell, cupro, acetate, triacetate, cellulon), such as rubber fibers, such as plant protein fibers and/or such as animal protein fibers and/or natural fibers made of cotton, sisal, flax, silk, hemp, linen, coconut or wool. The present invention, however, is not confined to the materials stated; it is instead possible, as evident to the skilled person without having to take an inventive step, to use a multiplicity of further fibers in order to produce the carrier.

Likewise suitable, furthermore, are yarns fabricated from the fibers specified.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials—in other words, be the single kind.

The yarns or threads of the woven fabrics may be in the form of filaments. For the purposes of this invention, a filament refers to a bundle of parallel individual linear fibers/filaments, often also referred to in the literature as a multifilament. This fiber bundle may optionally be given inherent strengthening by torsion, and is then referred to as spun or folded filaments. Alternatively, the fiber bundle can be given inherent strengthening by entangling using compressed air or water jets. In the text below, for all of these embodiments, only the term “filament” will be used, in a generalizing way.

The filament may be textured or smooth and may have point strengthening or no strengthening.

A preferred material used for the textile carrier is polyester, owing to the outstanding aging resistance and the outstanding media resistance with respect to chemicals and service fluids such as oil, gasoline, antifreeze, and the like. Polyester, moreover, has the advantage of leading to a highly abrasion-resistant and temperature-stable carrier, which is particularly important for the specific end use for the bundling of cables in automobiles and, for example, in the engine compartment. According to one embodiment of the invention, the carrier used is a PET nonwoven or a woven PET fabric.

The basis weight of the textile carrier is advantageously between 30 g/m² and 300 g/m², more advantageously between 50 g/m² and 200 g/m², very advantageously between 50 g/m² and 150 g/m², especially advantageously between 70 g/m² and 130 g/m².

With further preference the textile carriers have a flexural stiffness in the range from 0 to 30 mN/60 mm as unprocessed carriers (MD, machine direction), optionally from 2 to 30 mN/60 mm as unprocessed carriers (MD), resulting in very good flagging-free products and also great ease of unwind with low acrylate dispersion coat weight.

According to one preferred embodiment of the invention, the adhesive, following application to the carrier, has been absorbed to an extent of more than 10%, preferably more than 25%, more preferably more than 50% into the carrier. A numerical value of 25% here, for example, means that the adhesive has penetrated the thickness of the textile carrier over a layer thickness of 25%—that is, in the case of a carrier having a thickness of 100 μm, has penetrated over a layer thickness of 25 μm within the carrier—beginning from the surface of the carrier on which the adhesive has been coated, and in a direction perpendicular to the plane generated by the longitudinal and transverse directions respectively.

Also suitable for the adhesive tape is a carrier material which consists of paper, of a laminate, of a film (for example, PP, PE, PET, PA, PU), of foam or of a foamed film.

These nontextile sheetlike materials are especially appropriate when specific requirements necessitate such a modification of the invention. Films are generally thinner in comparison with textiles, for example, and, as a result of the imperforate layer, offer additional protection against penetration by chemicals and service fluids such as oil, gasoline, antifreeze, and the like into the actual cable area, and can be substantially adapted to requirements by an appropriate selection of the material from which they are constructed: with polyurethanes or polyolefin copolymers, for example, flexible and elastic jackets can be produced; with polyester and polyamides, good abrasion resistance and temperature stability are achieved.

Foams or foamed films, on the other hand, possess the qualities of more substantial space filling and of good soundproofing—where a length of cable is laid, for example, in a ductlike or tunnel-like area in the vehicle, a jacketing tape of appropriate thickness and soundproofing can prevent disruptive flapping and vibration from the outset.

Preference is given to a laminate of the textile carrier and of polymeric layer or film applied at least to one side of the textile carrier. It is additionally possible for films and/or polymeric layers to have been applied on the top side and the bottom side of the textile carrier. Application may take place by lamination or by extrusion.

In a preferred variant, the textile carrier is provided on its bottom side with a film, which on the other side is furnished with a PSA.

Suitable material for films or polymeric materials comprises films such as, for example, PP, PE, polyester, PA, PU or PVC. The films themselves may consist in turn of a plurality of individual plies, as for example of plies which are coextruded to form film.

Preference is given to polyolefins, but copolymers of ethylene and polar monomers such as styrene, vinyl acetate, methyl methacrylate, butyl acrylate or acrylic acid are also included. It may be a homopolymer such as HDPE, LDPE, MDPE, or a copolymer of ethylene with a further olefin such as propene, butene, hexene or octene (for example, LLDPE, VLDPE). Also suitable are polypropylenes (for example, polypropylene homopolymers, random polypropylene copolymers or polypropylene block copolymers).

The film preferably has a thickness of 12 μm to 100 μm, more preferably 28 to 50 μm, more particularly 35 μm.

The film may be colored and/or transparent.

Lastly, the adhesive tape may have a liner material, with which the one or two layers of adhesive are lined before use. Suitable liner materials also include all of the materials set out comprehensively above.

Preference is given to using a nonlinting material such as a polymeric film or a well-glued, long-fiber paper.

If the adhesive tape described is to be of low flammability, this quality can be achieved by adding flame retardants to the carrier and/or to the adhesive. These retardants may be organobromine compounds, if required with synergists such as antimony trioxide, although, with regard to the absence of halogen from the adhesive tape, preference will be given to using red phosphorus, organophosphorus compounds, mineral compounds, or intumescent compounds such as ammonium polyphosphate, alone or in conjunction with synergists.

The adhesive coat weight, based on the area of adhesive tape, is preferably between 40 and 160 g/m², more preferably between 60 and 130 g/m², with further preference between 80 and 100 g/m².

The general expression “adhesive tape” in the context of this invention encompasses all sheetlike structures such as two-dimensionally extended sheets or sheet sections, tapes with extended length and limited width, tape sections and the like, and also, lastly, diecuts or labels.

The adhesive tape therefore has a longitudinal extent and a latitudinal extent. The adhesive tape also has a thickness, extending perpendicularly to both extents, with the latitudinal extent and longitudinal extent being multiple times greater than the thickness. The thickness is very largely the same, preferably exactly the same, over the entire superficial extent of the adhesive tape as defined by length and width.

The adhesive tape is present in particular in the form of a sheet web. A sheet web is an object whose length is multiple times greater than the width, with the width being approximately and preferably exactly the same along the entire length.

The adhesive tape may be produced in the form of a roll, in other words rolled up onto itself in the form of an Archemedian spiral.

Applied to the reverse face of the adhesive tape may be a reverse-face varnish, in order to exert a favorable influence on the unwind properties of the adhesive tape wound into the Archemedian spiral. This reverse-face varnish may for this purpose be furnished with silicone compounds or fluorosilicone compounds and also with polyvinylstearylcarbamate, polyethyleneiminestearylcarbamide or organofluorine compounds as abhesive substances.

The adhesive may be applied in a longitudinal direction of the adhesive tape, in the form of a stripe, the width of the stripe being lower than that of the carrier of the adhesive tape. Depending on the particular utility, there may also be a plurality of parallel stripes of the adhesive coated on the carrier material.

The position of the stripe on the carrier is freely selectable, with preference being given to an arrangement directly at one of the edges of the carrier.

The adhesive is preferably applied over the full area on the carrier.

Provided on the adhesive coating of the carrier there may be at least one stripe of a covering, extending in the longitudinal direction of the adhesive tape and covering between 20% and 90% of the adhesive coating.

The stripe preferably covers in total between 50% and 80% of the adhesive coating. The degree of coverage is selected according to the application and to the diameter of the cable harness.

The percentage figures stated relate to the width of the stripes of the covering in relation to the width of the carrier.

In accordance with one preferred embodiment of the invention there is exactly one stripe of the covering present on the adhesive coating.

The position of the stripe on the adhesive coating is freely selectable, with preference being given to an arrangement directly at one of the longitudinal edges of the carrier. In this way an adhesive stripe is produced which extends in the longitudinal direction of the adhesive tape and finishes at the other longitudinal edge of the carrier.

Where the adhesive tape is used for jacketing a cable loom, by the adhesive tape being passed in a helicoidal movement around the cable loom, the wrapping of the cable loom may be accomplished by bonding the adhesive of the adhesive tape only to the adhesive tape itself, with the substrate not coming into contact with any adhesive.

The cable loom jacketed in this way has a very high flexibility as a result of the absence of fixing of the cable by any adhesive. Consequently the flexibility of said cable loom on installation—particularly in narrow passages or sharp bends—is significantly increased.

If there is a desire for a certain degree of fixing of the adhesive tape on the substrate, then jacketing may be accomplished by bonding part of the adhesive stripe to the adhesive tape itself and another part to the substrate.

In another advantageous embodiment, the stripe is applied centrally on the adhesive coating, thereby producing two adhesive stripes extending on the longitudinal edges of the carrier in the longitudinal direction of the adhesive tape.

For the secure and economic application of the adhesive tape in said helicoidal movement around the cable loom, and to counter the slipping of the resultant protective wrapping, the two adhesive stripes each present on the longitudinal edges of the adhesive tape are advantageous, especially if one stripe, which is usually narrower than the second stripe, serves as a fixing aid, and the second, broader stripe serves as a fastener. In this way the adhesive tape is bonded to the cable in such a way that the cable loom is secured against slipping but is nevertheless flexible in design.

In addition there are embodiments in which more than one stripe of the covering is applied to the adhesive coating. Where reference is made only to one stripe, the skilled person reads this, conceptually, as accommodating the possibility that there may well be two or more stripes covering the adhesive coating at the same time.

The procedure for producing the adhesive tape of the invention involves nothing more than the coating of the carrier directly with the dispersion in one or more operations carried out in succession. In the case of textile carriers, the untreated textile can be coated directly or by a transfer process. Alternatively the textile may be pretreated with a coating (using any desired film-forming substance, from solution, dispersion, melt and/or radiation-curing), before then being provided, in a downstream operation, directly or by a transfer process, with the PSA.

Application assemblies used are the customary ones: wire doctor, coating bar, roll application, nozzle coating, twin-chamber doctor blade, multiple cascade die.

On the basis of the positive properties outlined, the adhesive tape can be used outstandingly for insulating and wrapping wires or cables.

The adhesive tape is preferably used for the jacketing of elongate items such as, more particularly, cable harnesses, with the adhesive tape being passed in a helical movement around the elongate item. This produces the form of a helix (also called screw, screw line, cylindrical spiral, or coil; a helix is a curve which winds with constant gradient around the outside of a cylinder).

In one variant, the elongate item is enveloped by the adhesive tape in an axial direction. The wrapping of a cable loom with the adhesive tape described takes place in this case not, in the customary manner, in the form of a helical line, but instead such that, during wrapping, a longitudinal axis of the tape is oriented substantially parallel to the direction in which the cable loom extends. As viewed in cross section, the adhesive tape in this case is in the form of an Archemedian spiral around the cable loom. With this type of wrapping the loom is also said to be “wound” with the tape.

Likewise embraced by the concept of the invention is a jacketed elongate item, such as, in particular, a cable harness, jacketed with an adhesive tape of the invention, and also a vehicle comprising an elongate item thus jacketed.

According to one embodiment of the invention, the elongate item is a cable strand comprising a bundle of a plurality of cables such as 3 to 1000 cables, preferably 10 to 500 cables, more particularly between 50 and 300 cables.

On account of the outstanding suitability of the adhesive tape, it can be used in a jacket that consists of a covering where, at least in one edge region of the covering, the self-adhesive tape is present, and is bonded on the covering in such a way that the adhesive tape extends over one of the longitudinal edges of the covering, and preferably in an edge region which is narrow by comparison with the width of the covering.

One such product and also optimized embodiments thereof are disclosed in EP 1 312 097 A1. EP 1 300 452 A2, DE 102 29 527 A1, and WO 2006/108871 A1 show ongoing developments for which the adhesive tape of the invention is likewise very suitable. The adhesive tape of the invention may also find use in a method of the kind disclosed by EP 1 367 608 A2.

Finally, EP 1 315 781 A1 and also DE 103 29 994 A1 describe embodiments of adhesive tapes of a kind also possible for the adhesive tape of the invention.

With further preference, the adhesive tape, on bonding to cables with PVC jacketing and to cables with polyolefin jacketing, does not destroy these systems when an assembly composed of cables and adhesive tape is stored, in accordance with LV 312, at temperatures above 105° C. for up to 3000 h and then the cables are bent around a mandrel.

The skilled person would have expected the use of common fillers such as kaolin to result in significant detractions from the peel adhesion performance. However, surprisingly, this is not the case.

The use according to the invention makes it possible for the plasticizer content in each case in wt % in cable jackets after at least 2000 h still to be at least 60% of the original content in the cable jacket, especially measured under/according to the conditions of LV 312.

This refers preferably to the plasticizer content of PVC cable jackets, particularly in terms of the plasticizers comprising TOTM, DOP (dioctyl phthalate, di-2-ethylhexyl phthalate), DINP (diisononyl phthalate), TOTM (trioctyl trimellitate), DIDP (diisodecyl phthalate), triethyl citrate or adipic acid-based plasticizers such as diethylhexyl adipate and diethyloctyl adipate. More preferably the plasticizer content of cable jackets enveloped with the adhesive tapes of the invention after 2000 h is greater than or equal to 66%, preferably greater than or equal to 70%, more preferably greater than or equal to 80%, and with further preference the content after 2500 h or after 3000 h, in each case independently, is still a plasticizer content of 60% based on the original content.

As the examples show, the only phyllosilicate suitable out of the known phyllosilicates, surprisingly and in a way unforeseeable for the skilled person, is kaolin. Other clay minerals such as montmorillonite, nontronite, hectorite, saponite, sauconite, beidellite, allevardite, illite, halloysite, attapulgite and/or sepiolite, and also disteardimonium hectorite. Hectorites are M_{0.3}⁺(Mg_{2.7}Li_{0.3})[Si₄O₁₀(OH)₂], M⁺ usually=Na⁺, belonging to the smectites, the monoclinic clay mineral similar to montmorillonite lead to failure, and modified three-layer phyllosilicates as well or such as, for example, illites, smectites or vermiculites, are unsuitable, despite being set out as particularly suitable in DE 10 2014 223 451 A1.

The purpose of the text below is to illustrate the adhesive tape in more detail using a number of figures, without wishing thereby to bring about any restriction of whatever kind.

### IN THE FIGURES

FIG. 1 shows the adhesive tape in a lateral section;

FIG. 2 shows a detail of a cable loom which is composed of a bundle of individual cables and is jacketed with the adhesive tape of the invention;

FIG. 3 shows an advantageous application of the adhesive tape; and

FIG. 4 shows a ruler measuring a flagging value of the adhesive tape.

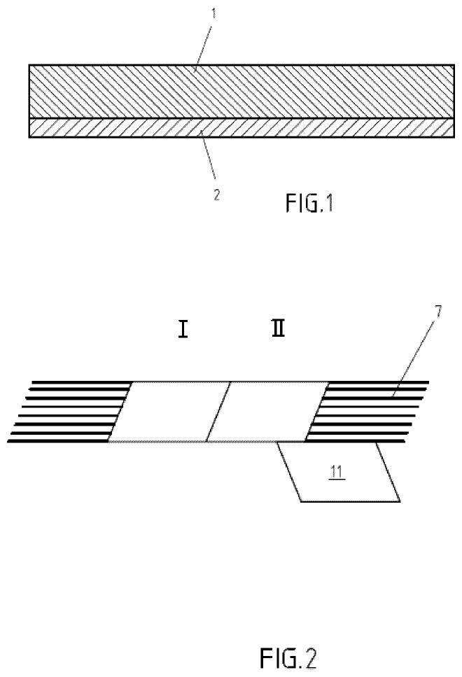

Shown in FIG. 1, in a section in the cross direction (transverse section), is the adhesive tape, consisting of a woven fabric carrier 1, one side of which bears an applied layer of a self-adhesive coating 2 based on an acrylate dispersion.

The adhesive has been absorbed to an extent of 20% into the carrier, thus resulting in optimum anchoring and at the same time improving the hand tearability of the carrier.

FIG. 2 shows a detail of a cable loom which is composed of a bundle of individual cables 7 and is jacketed with the adhesive tape 11 of the invention. The adhesive tape is passed in a helicoidal movement around the cable loom.

The detail of the cable loom shown has two turns I and II of the adhesive tape. Further turns will extend toward the left, but are not shown here.

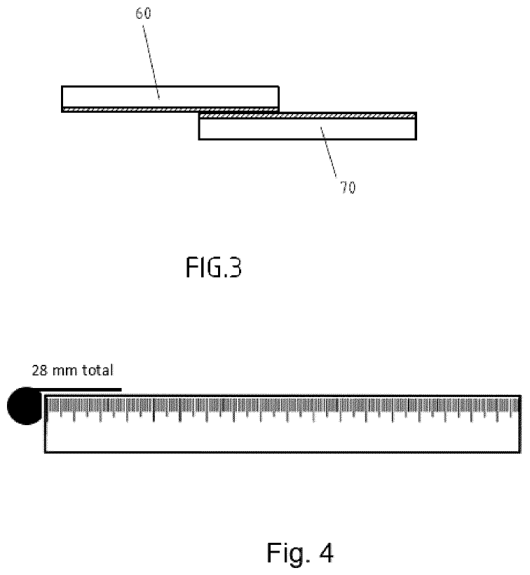

In a further embodiment for jacketing, two tapes 60, 70 of the invention, furnished with an adhesive, are laminated with their adhesives at an offset (preferably by 50% in each case) to one another, producing a product as shown in FIG. 3.

### EXAMPLES

### Outline of the Examples

The adhesive tape of the invention is described below in a preferred embodiment by means of an example, without wishing thereby to subject the invention to any restriction whatsoever.

In addition, comparative examples are given, which show unsuitable adhesive tapes.

To illustrate the invention, example adhesive tapes were produced according to the following scheme:

The PSA dispersions were adjusted, by stirred incorporation of a polyurethane associative thickener (Borchigel 0625, OMG Borchers), to a viscosity of approximately 1000 Pa*s at a shear rate of 0.01 s⁻¹ (measured using cone/plate geometry in rotation mode with a DSR 200 N rheometer from Rheometric Scientific).

The nonwoven web is a Maliwatt stitchbonded web with a basis weight of 55 g/m², consisting of PET fibers with a length of 64 mm and a thickness of 3 den and with a PET stitching thread with a linear density of 50 dtex, stitched with 22 threads per inch (corresponding to 9 threads/centimeter of web width).

Using a film-drawing apparatus, the Maliwatt was coated with the thickened example PSA dispersion in such a way as to result, after drying in a forced-air oven at 85° C. for 5 minutes, in an adhesive coat weight of 90 g/m².

Assessment Criteria

Implementation of Tests

Unless expressly stated otherwise, the measurements are carried out under test conditions of 23±1° C. and 50±5% relative humidity.

Measurement of Flagging Resistance by the SWAT Method

The SWAT test is utilized in order to investigate the flagging behavior of adhesive tapes after they have been wound spirally around a cable.

The test is carried out under standard conditions (23±1° C. and 50±5% relative humidity) and at 40° C. The elevated temperature simulates the more difficult requirements during transport.

The test uses an adhesive tape 19 mm wide. It is wound manually around a cable sheathed with ETFE (ethylene-tetrafluoroethylene) and having a diameter of 1 mm, four times) (1440°, without additional pressure. Scissors are used to cut the adhesive tape.

A flag on average 5 mm long is assumed to remain unless the end of the adhesive tape is pressed down.

A total of seven turns around the cable are produced.

The flags are measured with a ruler after three days, ten days and 30 days under standard conditions. This is shown by FIG. 4. The absolute flagging value is computed by subtracting 5 mm from the flag length actually measured.

In FIG. 4, therefore, the flagging value is 23 mm (28 mm-5 mm).

The flagging value reported as the result is the result of the mean flagging values of the seven turns. The test at 40° C. is carried out analogously in customary drying cabinets.

The adhesive tape of the invention is evaluated subsequently at 40° C. in a drying cabinet by the SWAT method specified.

Here, a value of ≤10 mm is deemed to be the lower limit of resistance to flagging.

Means <5 receive a score of 2, means from 5 to 10 receive a score of 1 and means >10 receive a score of 0.

Measurement of cable compatibility for cables having T2-PVC insulation, based on LV 312

The measurement is carried out in analogy to the measurement method specified in LV 312. The measurements take place in each case at 105° C. (T2).

Measurement of Peel Adhesion

The peel adhesion on steel was measured according to ASTM D3330.

Unwind Force

Measurement of unwind force to LV 312 at a take-off speed of 30 m/min.

Softening Point

Measurement according to ASTM E28-99 (2009)

Measurement of Glass Transition Temperatures

The glass transition temperatures were measured on the DSC 204 F1 “Phönix” Dynamic Scanning Calorimeter from Netzsch, Germany, in 25 μl aluminum crucibles with a perforated lid, under a nitrogen atmosphere (20 ml/min gas flow rate). The initial sample mass was 8±1 mg. The samples were measured twice from −140° C. to 200° C. with a heating rate of 10 K/min. The subject of analysis was the 2nd heating curve. The method is based on DIN 53 765.

Dynamic Viscosity Measurement

The viscosity measurement is carried out with a DSR 200 N rheometer from Rheometric Scientific at room temperature and in rotation mode at a shear rate of 0.01 s⁻¹ using a cone-plate system having a diameter of 50 mm, and alternatively with a shear rate of 10 s⁻¹.

Gel Content

The gel content is determined by Soxhlet extraction, which extracts soluble constituents from polymers in a continuous extraction. In the case of determination of the gel content of (aqueous) polyacrylate PSAs, a suitable solvent such as tetrahydrofuran, for example, extracts the soluble fractions of a polymer—the so-called sol—from the insoluble fractions—the so-called gel. Preparation: the composition for extraction is applied to siliconized release paper as a thin film—generally with a layer thickness of 120 μm—and dried for around 12 h at 80° C. (forced-air drying cabinet). The films are kept in a desiccator over desiccant. The Whatman 603 extraction sleeves are dried at 80° C. for 12 h, the empty weight of the sleeves is ascertained, and they are stored in a desiccator prior to use.

Gel Content Determination

Around 1 g of PSA is weighed into an extraction sleeve. A 100 ml round-bottom flask of the Soxhlet apparatus is filled with 60 ml of tetrahydrofuran and heated to boiling. THF vapors ascend through the vapor tube of the Soxhlet apparatus and condense in the condenser, and THF drips into the extraction sleeve and extracts the sol fraction. In the course of the extraction, the THF I runs back into the flask with the extracted sol. Dissolved sol accumulates increasingly in the flask. After 72 h of continuous extraction, the sol is completely dissolved in the THF. After cooling of the apparatus to room temperature, the extraction sleeve is then removed and dried at 80° C. over 12 h. The sleeves are kept in the desiccator until their mass is constant, after which they are weighed.

The gel content of the polymer is calculated according to the following formula:

$$Gel content = \frac{{m}_{3} - {m}_{1}}{{m}_{2} - {m}_{1}} \cdot 100 \%$$

where
m₁: mass of extraction sleeve, empty
m₂: mass of extraction sleeve+polymer
m₃: mass of extraction sleeve+gel

Flexural Stiffness

The flexural stiffness is determined using a Softometer KWS basic 2000 mN (from Wolf Messtechnik GmbH). (MD) stands for machine direction, meaning that the flexural stiffness is determined in the machine direction.

The criteria for an application-competent adhesive tape particularly suitable for the wrapping of cables are as follows:
peel adhesion on steel [N/cm];
unwind force (30 m/min) [N/cm]; and
cable compatibility [h].

For these criteria, five ranges are stipulated in each case, and the results are assigned to these ranges.

Furthermore, a determination is made of those ranges which defined very good or good performance, those which characterized acceptable performance, and those which characterized unacceptable performance.

| Peel adhesion on | | Unwind force (30 m/min) | | Cable compatibility | |
|---|---|---|---|---|---|
| steel [N/cm] | | [N/cm] | | [h] | |
| ASTM D3330 | | LV312: | | LV312: | |
| 1 | >2.5 | 1 | 4-6 | 1 | >2500 |
| 2 | 2.0-2.5 | 2 | 3-4, 6-9 | 2 | 2000-2500 |
| 3 | 1.5-2.0 | 3 | 2-3, 9-12 | 3 | <2000 |
| 4 | 1.0-1.5 | 4 | 1-2, 12-15 | | |
| 5 | <1.0 | 5 | <1, >15 | | |

The mandates for the four properties are as follows:

| | Very good or good | Unacceptable |
|---|---|---|
| Peel adhesion on steel | Ranges 1 and 2 | Ranges 3 to 5 |
| Unwind force | Ranges 1 and 2 | Ranges 3 to 5 |
| Cable compatibility | Range 1 | Ranges 2 and 3 |

To illustrate the inventive idea, polymer dispersions with the following comonomer composition were tested:

| | Comonomer composition | | | | | | | | |
|---|---|---|---|---|---|---|---|---|---|
| | 2-EHA | BA | MMA | AA | AcN | EA | HEA | VAc | Styrol |
| Polymer 1 | 45 | 46 | x | 5 | 4 | x | x | x | x |
| (P1) | | | | | | | | | |
| Polymer 2 | 98 | x | x | 2 | x | x | x | x | x |
| (P2) | | | | | | | | | |
| Polymer 3 | 51 | x | x | x | x | 41 | x | 4 | 4 |
| (P3) | | | | | | | | | |
| Polymer 4 | 40 | 41 | 8 | 1.2 | x | x | 1.8 | 8 | x |
| (P4) | | | | | | | | | |

2-EHA: 2-Ethylhexylacrylate
BA: n-Butylacrylate
MMA: Methylmethacrylate
AA Acrylic acid
AcN Acrylnitrile
EA Ethylacrylate
HEA 2-Hydroxyethylacrylate
VAc Vinylacetate

These polymers are blended with different resins for which the softening temperature is specified.

| | | | R&B |
|---|---|---|---|
| | Name | Chemical Composition | [° C.] |
| Resin 1 (H1) | Snowtack 100G E | Colophony ester resin | 95.5 |
| Resin 2 (H2) | Snowtack 110X E | Pentaerythritol ester of | 104.8 |
| | | colophony | |
| Resin 3 (H3) | Snowtack TP 600G E | Terpenic phenol | 92.8 |
| Resin 4 (H4) | Snowtack FH 95G E | fully hydrogenated rosin | 90 |
| | | ester | |

| | Ac | | | | Visc. | Visc. | | | |
|---|---|---|---|---|---|---|---|---|---|
| | dispersion | Resin | Phyllosilicate | Thickener | 10/s | 0.01/s | Peel | Unwind | Cable |
| Example | [wt %] | [wt %] | [wt %, type] | [Product] | [Pa * s] | [Pa * s] | adhesion | force | compatibility |
| 1 | P1, 82 | H1, 15 | 3, Kaolin | Tubivis | 41.9 | 3471 | 1 | 4 | 3 |
| | | | | DL600 | | | | | |
| 2 | P2, 88 | H2, 0 | 12, Kaolin | Borchi Gel | 63.0 | 3365 | 4 | 3 | 1 |
| | | | | 0625 | | | | | |
| 3 | P3, 94 | H3, 6 | 0, Kaolin | Rheo-Byk | 12.8 | 1102 | 4 | 3 | 1 |
| | | | | 425 | | | | | |
| 4 | P4, 90 | H4, 5 | 5, Kaolin | Evo Dot VD2 | 8.9 | 1314 | 4 | 4 | 1 |
| 5 | P1, 91 | H2, 9 | 0, Kaolin | Borchi Gel | 40.7 | 3685 | 2 | 3 | 2 |
| | | | | 0625 + Evo | | | | | |
| | | | | Dot VD2 | | | | | |
| 6 | P2, 89 | H3, 8 | 3, Kaolin | Tubivis | 41.2 | 3471 | 1 | 2 | 1 |
| | | | | DL600 | | | | | |
| 7 | P3, 89 | H4, 6 | 5, Kaolin | Rheovis | 53.6 | 3917 | 1 | 1 | 1 |
| | | | | PU1191 + | | | | | |
| | | | | Rheovis | | | | | |
| | | | | AS1130 | | | | | |
| 8 | P4, 88 | H1, 4 | 8, Kaolin | Borchi Gel | 46.6 | 3594 | 1 | 1 | 1 |
| | | | | 0625 + Evo | | | | | |
| | | | | Dot VD2 | | | | | |
| 9 | P1, 93 | H3, 1 | 6, Kaolin | Rheovis | 72.3 | 5217 | 2 | 1 | 1 |
| | | | | PU1191 + | | | | | |
| | | | | Rheovis | | | | | |
| | | | | AS1130 | | | | | |
| 10 | P2, 91 | H4, 4 | 5, Kaolin | Borchi Gel | 121.5 | 9319 | 1 | 4 | 1 |
| | | | | 0625 + Evo | | | | | |
| | | | | Dot VD2 | | | | | |
| 11 | P3, 90 | H1, 5 | 5, Laponite | Byk 425 | 32.7 | 9221 | 5 | 5 | 1 |
| | | | SL-25 | | | | | | |
| 12 | P4, 91 | H2, 5 | 4, Smektit | Rheovis | 39.3 | 2976 | 3 | 2 | 1 |
| | | | | PU1191 + | | | | | |
| | | | | Rheovis | | | | | |
| | | | | AS1130 | | | | | |

Tubivis DL600 (CHT R.Beitlich): Thickener based on acrylic acid
Borchigel 0625 (OMG Borchers): Polyurethane associative thickener
Rheo-Byk 425 (Byk): Thickener based on a urea modified polyurethane
Evo Dot VD2 (DyStar Colours Germany): Thickener based on a polyacrylic acid derivative
Rheovis PU1191 (BASF): Polyurethane associative thickener
Rheovis AS1130 (BASF): Thickener based on an acrylate copolymer

As the examples show, the use of 1 to 10 wt % of kaolin (not Laponite SL-25 or smectite!) optimizes the unwind force and leads surprisingly to a higher peel adhesion. Accordingly, as a result of the positive peel adhesion effect of kaolin, the quantity of resin can be kept low, specifically at less than 10 wt %.

Examples 6 to 9 show the best trade-off in terms of the product properties.

Examples 1 to 5 and 10 to 12 are comparative examples.

1-20. (canceled)

21. An elongate item jacketed with an adhesive tape, the adhesive tape comprising:
a carrier; and
a pressure-sensitive adhesive, applied on at least one side of the carrier, in the form of a thickened dried polymer dispersion,
wherein the unthickened dried polymer dispersion comprises:
(a) 30.0 to 98.0 wt % of monomeric acrylates;
(b) 0 to 50.0 wt % of ethylenically unsaturated comonomers which are not acrylates;
(c) 1.0 to 10.0 wt % of tackifier; and
(d) 1.0 to 10.0 wt % of kaolin,
wherein an organic rheological additive is added to the polymer dispersion such that the polymer dispersion has a viscosity before drying of 40 Pa*s up to 100 Pa*s at a shear rate of 10/s and a viscosity of 3000 Pa*s up to 8000 Pa*s at a shear rate of 0.01/s.

22. The elongate item according to claim 21, wherein the monomeric acrylates are selected from the group consisting of alkyl (meth)acrylates, acid amides, and a mixture thereof.

23. The elongate item according to claim 21, wherein the ethylenically unsaturated comonomers are selected from the group consisting of ethylene, aromatic vinyl monomers, divinylbenzene, vinyl esters of carboxylic acids containing up to 20 carbon atoms, vinyl ethers of alcohols containing up to 10 carbon atoms, vinyl halides, itaconic acid, maleic acid, fumaric acid and/or maleic anhydride, acrylonitrile and/or methacrylonitrile, unsaturated hydrocarbons having 3 to 8 carbon atoms, and a mixture thereof.

24. The elongate item according to claim 21, wherein the ethylenically unsaturated comonomers have an acid or acid hydride function and are at least one selected from the group consisting of acrylic acid, methacrylic acid, itaconic acid, maleic acid, fumaric acid, and maleic anhydride.

25. The elongate item according to claim 21, wherein the polymer dispersion has a gel content of greater than or equal to 40% determined via Soxhlet extraction.

26. The elongate item according to claim 21, wherein the pressure-sensitive adhesive comprises 3 to 7 wt % of kaolin.

27. The elongate item according to claim 21, wherein the pressure-sensitive adhesive comprises 3 to 8 wt % of tackifier.

28. The elongate item according to claim 21, wherein the glass transition temperature of the pressure-sensitive adhesive is below +15° C. (determined by DSC (Differential Scanning Calorimetry) in accordance with DIN 53765 at a heating rate of 10 K/min).

29. The elongate item according to claim 21, wherein at least one of:
the pressure-sensitive adhesive has a peel adhesion on steel according to ASTM D3330 of at least 2.0 N/cm (for a surface weight of the adhesive of 100 g/m² on woven polyester fabric carrier); and
the pressure-sensitive adhesive has an unwind force of 3.0 N/cm to 9.0 N/cm at 30 m/min.

30. The elongate item according to claim 21, wherein the carrier is a textile carrier comprising a nonwoven material or a woven fabric.

31. The elongate item according to claim 30, wherein the woven fabric is a woven polyester fabric.

32. The elongate item according to claim 22, wherein the monomeric acrylates comprise at least one selected from the group consisting of:
the alkyl (meth)acrylates comprise at least one of C₁ to C₂₀ alkyl (meth)acrylates and C₁ to C₁₀ hydroxyalkyl (meth)acrylates;
the acid amides comprises an acrylamide or a methacrylamide; and
a mixture thereof.

33. The elongate item according to claim 23, wherein the ethylenically unsaturated comonomers comprise at least one selected from the group consisting of:
the ethylene, aromatic vinyl monomers are selected from styrene, α-methylstyrene, and vinyltoluene;
the vinyl esters of carboxylic acids are selected from vinyl laurate;
the vinyl ethers of alcohols are selected from vinyl methyl ether or vinyl isobutyl ether;
the vinyl halides are selected from vinyl chloride or vinylidene dichloride;
the unsaturated hydrocarbons are selected from propene, butadiene, isoprene, 1-hexene or 1-octene; and
a mixture thereof.

34. The elongate item according to claim 25, wherein the gel content of the polymer dispersion is greater than or equal to 45% determined via Soxhlet extraction.

35. The elongate item according to claim 31, wherein the woven polyester fabric has a construction as follows:
the thread count in the warp is 10 to 60/cm;
the thread count in the weft is 10 to 40/cm;
the warp threads possess a yarn weight of between 40 and 400 dtex; and
the weft threads possess a yarn weight of between 40 and 660 dtex.

36. The elongate item according to claim 35, wherein at least one of:
the yarn weight of the warp threads is between 44 and 330 dtex; and
the yarn weight of the weft threads is between 44 and 400 dtex.

37. The elongate item according to claim 21, wherein the adhesive tape consists of:
the carrier; and
the pressure-sensitive adhesive applied on one side of the carrier.

38. A vehicle comprising the elongate item according to claim 21.

39. A method of producing the elongate item according to claim 21, the method comprising:
leading the adhesive tape according to claim 21 in a helical line around an elongate item; or
enveloping an elongate item in the axial direction by the adhesive tape according to claim 21.
